(19) United States
(12) Patent Application Publication
(10) Pub. No.: US 2006/0261506 A1
(43) Pub. Date: Nov. 23, 2006

(54) SERVO SPEED CONTROL IN MANUFACTURE OF COMPOSITE LUMBER

(76) Inventor: Michael J. Hurkes, South Portland, ME (US)

Correspondence Address: HOVEY WILLIAMS LLP, 2405 GRAND BLVD., SUITE 400, KANSAS CITY, MO, 64108, US

(21) Appl. No.: 11/462,237

(22) Filed: Aug. 3, 2006

Related U.S. Application Data
(62) Division of application No. 10/790,483, filed on Mar. 1, 2004.

(51) Int. Cl. B29C 47/92

(52) U.S. Cl. 264/40.7

(57) ABSTRACT

Composite lumber manufacturing apparatus and methods are disclosed that involve use of all extruder in connection with all extrudate speed detector providing an extruder speed indication that provides extrudate speed information to a servo-controlled cutter to cut the composite lumber as it is extruded without communicating imperfections to portions of still-elastic extrudate.

### RELATED APPLICATIONS

This is a divisional of U.S. patent application Ser. No. 10/790,483, filed Mar. 1, 2004, incorporated by reference herein.

### BACKGROUND OF THE INVENTION

1. Field of the Invention

The present teaching relates to methods and systems for manufacturing composite lumber using servo speed control in connection with servo speed-controlled cutters.

2. Description of the Prior Art

While wood lumber is a naturally renewable resource, the demand for wood is consistently high. Furthermore, the supply of construction-grade wood has continued to diminish. Accordingly, there is an urgency to find alternative sources of wood-like construction materials. There is a high demand for mass-produced artificial lumber, which can be manufactured from a mixture of ingredients such as recycled cellulose, which can be obtained from waste wood products such as wood meal, wood chips, saw dust, and newspapers. These cellulose fibers are combined with a heated thermoplastic material and extruded to into a shape having a desired cross-sectional area.

The inline cutting of extruded cellulose composite lumber is known to be difficult and problematic. Tin order to cut extruded composite lumber as it is being extruded it is necessary to accommodate subtle speed variations of the extruded lumber as it is being extruded. A saw table must move with the extrudate as the saw cuts the extrudate. Otherwise, any speed mismatch will be transmitted via the solidified extrudate to the newly-extruded and not yet hardened portion of the extrudate, for example at the die face of the extruder, creating a wave or imperfection in the extruded lumber. Frequently, the wave propagates itself through the manufacturing causing the board or boards containing the wave to become scrap.

Conventional solutions to compensating for the subtle variations in the speed of the extrudate include the use of cutoff saws that employ finely balanced springs or pneumatic cylinders to compensate for the subtle speed variations of the extrudate. The conventional solutions are expensive and more problematically require constant adjustment at intervals of approximately every 100 cutting cycles. Additionally, the known mechanical compensation schemes are subject to wear and static friction, which can cause failure in the manufacturing process.

### SUMMARY OF THE INVENTION

According to various embodiments, the present teaching enables composite lumber manufacturing apparatus and methods that involve use of all extruder in connection with an extrudate speed detector. The extrudate speed detector provides an extruder speed indication that provides extrudate speed information to a servo-controlled cutter to cut the composite lumber as it is extruded without communicating imperfections to still-elastic extrudate.

It is to be understood that both the foregoing, general description and the following detailed description are exemplary and explanatory only and are not restrictive of the invention as claimed.

The accompanying drawings, which are incorporated in and constitute a part of this specification, illustrate some embodiments of the invention, and together with the description serve to explain the principles of the invention.

### BRIEF DESCRIPTION OF THE DRAWINGS

FIG. 1 is a partial top view of a servo-controlled extrusion line constructed in accordance with the principles of the present teachings; and

FIG. 2 is a partial side view of a servo-controlled extrusion line constructed in accordance with the principles of the present teachings.

### DETAILED DESCRIPTION OF THE PREFERRED EMBODIMENTS

Composite materials consisting of recycled wood scraps and a thermoplastic material can be employed to satisfy the need for synthetic lumber. Generally, these composite lumbers are formed so that they may be used in many of the same applications as an all-wood product while offering advantages such as high resistance to rot, insects, and moisture. These products generally have the same workability as wood and are splinter-free. However, due to the extruding processes, and variations in the composition and spefically in the bulk density of the feedstock, there are problems and challenges presented in the manufacture of composite lumber.

The term “composite lumber” as used herein refers to lumber products composed of materials including a thermoplastic material such as polypropylene and a fibrous or cellulosic material. In various embodiments, the fibrous material is present in the ingredients at a level of from about 20-80% by weight, more preferably from about 30-70% by weight, and even more preferably from about 50-70% by weight, based upon the total weight of the ingredients taken as 100% by weight. The polypropylene is preferably present in the ingredients at a level of from about 20-80% by weight, more preferably from about 30-70% by weight, and even more preferably from about 30-50% by weight, based upon the total weight of the ingredients taken as 100% by weight.

In various embodiments, the included fibrous materials include those selected from the group consisting of sawdust, newspaper, alfalfa, wheat pulp, wood scraps (e.g., ground wood, wood flour, wood flakes, wood chips, wood fibers, wood particles), wood veneers, wood laminates, cardboard, straw, cotton, rice hulls, paper, coconut shells, peanut shells, bagasse, plant fibers, bamboo fiber, palm fiber, kenaf, and mixtures thereof. Furthermore, the average particle size of the fibrous material should be less than about ½ inch, and more preferably from about 1/32-⅛ inch. Finally, the particles of the fibrous material should have an average aspect ratio (i.e., the ratio of the length to the widest thickness) of at least about 10:1, preferably at least about 20:1, and more preferably from about 30:1 to about 50:1. The use of such long particles increases the flexural modulus of the product as compared to products with lower aspect ratios by at least about 25%, and preferably at least about 40%, thus causing the final composite product to have a stiffness comparable to natural wood.

In various embodiments, the polypropylene used use in connection with the present teachings is reactor flake polypropylene (i.e., the polymer flakes as they are produced in the reactor), preferably without any further treatment (e.g., without the addition of chemical additives or modifiers) to the polypropylene. In various embodiments, the polypropylene has a melt index at 230° C. of from about 0-10 g/10 min., preferably from about 0.1-4 g/10 min., and more preferably from about 0.1-1 g/10 min. Furthermore, it is preferred that the polypropylene has a bulk density of from about 20-40 lbs/ft³, and more preferably from about 28-32 lbs/ft³. The average fiber length or particle size of the polypropylene flakes utilized should be from about 350-1,000 μm, and preferably from about 500-700 μm,

The resulting composite product is in the form of a self-sustaining body and has an ASTM D-6109 flexural modulus of from about 600,000-1,100,000 psi, and preferably from about 8000,000-1,100,000 psi. The product should have an actual density of from about 40-70 lbs/ft³, and preferably from about 50-58 lbs/ft³.

A number of optional ingredients call also be added to modify or adjust the properties of the final composite product. Examples of such ingredients include acrylic process aids (e.g., Rohm and Haas K175, Kaneka Kane-Ace PA-101), UV stabilizers (e.g., CYTEC 3853S, CYTEC 3346), and coloring agents. If a process aid is utilized, it is preferably present in the ingredients at a level of from about 0.5-5% by weight, and more preferably from about 1-2% by weight, based upon the total weight of the ingredients taken as 100% by weight. These acrylic process aids are particularly useful in the present invention in spite of the fact that they are intended to be used in PVC products rather than polypropylene products.

Reference will now be made in detail to some embodiments of the invention, examples of which are illustrated in the accompanying drawings. Wherever possible, the same reference numbers are used throughout the drawings to refer to the same or like parts.

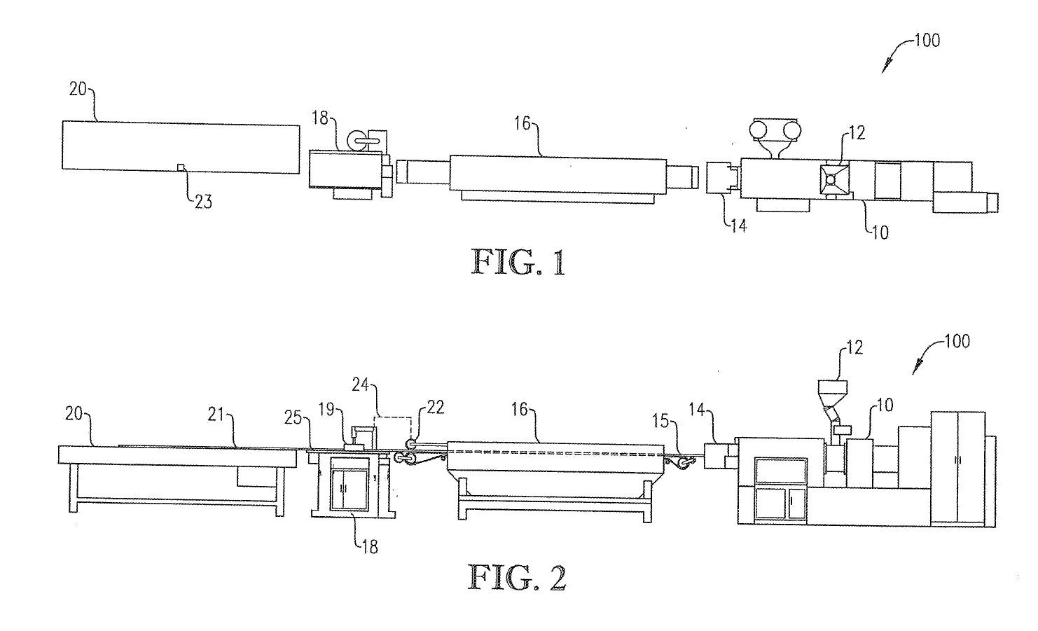

FIG. 1 is a partial top view of a servo-controlled extrusion line constructed in accordance with the principles of the present teachings. In various embodiments, extrusion line 100 generally includes an extruder 10, a spray bath 16, a servo-controlled cutter 18 or saw, and drop table 20. The extruder 10 has a hopper 12 for receiving composite materials such as polypropylene and sawdust. In various embodiments, the hopper 12 is fed blended composite materials from a weigh blender as described in copending U.S. patent application Ser. No. 09/790,017, entitled, Composite Products Comprising Cellulosic Materials and Synthetic Resins and Methods of Making the Same, which is hereby incorporated by reference in its entirety. The extruder 10 heats and extrudes the composite extrudate and forces the extrudate through extrusion die 14 in a cross-sectional configuration that is determined by the shape of the extrusion die 14. In various embodiments, the extrusion die 14 causes the composite extrudate to take on a generally rectangular configuration. In some embodiments, the extruded lumber is extruded in standard lumber sizes for use in the construction of exterior residential construction decking. In various other embodiments, composite lumber of the form of hollow-core 4″×4″ lumber lengths are manufactured. In various other embodiments, composite lumber is manufactured in the form of railings. It is understood that the extruder can be embodied by any type of extruder that can be used to extrude composite thermoplastic and fibrous materials. A presently preferred extruder is a conical twin screw extruder manufactured by Milacron Plastics Technologies Group of Batavia, Ohio.

When the composite lumber exits the extruder 10, it is in a heated plastic or semi-plastic states which is subject to deformation. Accordingly, the spray bath 16 is used to cool the extrudate before it is cut at the servo-controlled cutter 18. The spray bath 16 uses a cooling liquid such as water, which is cooled via a heat exchanger and recirculated via a pump. It is understood that cooling baths of any type capable of cooling the heated extrudate can be employed without departing from the present teachings.

Next, the cooled composite lumber is cut at the servo-controlled cutter 18 and stacked in connection with drop table 20. The servo-controlled cutter 18 can be any kind of servo-operated mechanism for cutting hardened composite materials. In a presently preferred embodiment, the servo-controlled cutter is a servo saw manufactured by Custom Downstream Systems of St-Laurent. Canada, model no. CSS 6.5-13. Alternatively, the servo-controlled cutter can be a servo-controlled fly knife, which employs a metal blade to cut the hardened extrudate 21. A servo-controlled fly knife can be used to cut extrudates of small cross sectional area, such as, for example small moldings.

Once the composite lumber is cut, it continues to be pushed along the line to the drop table 20. In various embodiments, a trigger 23 is actuated by the cut lumber as it is pushed down the line, causing the drop table 20 to tilt to one side and drop the piece of lumber into a stack of finished lumber pieces (not shown).

FIG. 2 is a partial side view of a servo-controlled extrusion line constructed in accordance with the principles of the present teachings. In connection with the extruder 10, composite materials are blended, heated, and extruded, through the extrusion die 14 to form the extrudate 15, which is initially extruded in a heated, semi-plastic or plastic state. The extrudate 15 passes through spray bath 16 and is cooled and hardened prior to being cut at the servo-controlled cutter 18.

Because of variations in the bulk density of the composite materials provided to the extruder 10, the extrudate 15 is extruded at a variable rate of speed. This variable rate of speed is measured by an extrudate speed detector 22, which is preferably an encoder wheel. In various embodiments, the encoder wheel rides on an upper surface of the cooled and hardened extrudate 21 as the extrudate exits the spray bath 16. In various embodiments, as it rotates the encoder wheel generates an electrical signal comprising a series of pulses, which are communicated to the servo-controlled cutter 18 via electrical cable 24. Based on the sequence of pulses communicated by the extrudate speed detector 22, the servo-controlled cutter 18 controls the speed of movements of its various parts.

In various embodiments, an upper surface of the table 925 of the servo-controlled cutter 18 is covered with low friction strips, comprising, for example, a Teflon™-type material, to allow the extrudate to slide over the tabletop without distorting the elastic portions of the extrudate 15. In these embodiments, the servo-controlled cutter 18 cuts pieces of lumber 91 as they are extruded in the following manner. First, the table 95 of the servo-controlled cutter 18 begins in a home position. The speed of the extrudate 15 is obtained by way of the extrudate speed detector 22 and communicated to the servo-controlled cutter 18 via, for example, cable 24. The table 25 begins moving at the speed of the extrudate 15. Next the clamp 19 comes down to tightly clamp the hardened extrudate 21 to the servo-controlled cutter table 25, as the table 25 continues to move at the speed of the extrudate 15. Next a rotary saw blade comes up through the table 25 cutting the composite lumber at the desired length, while still moving at the speed of the extrudate. In various embodiments, the extrudate speed detector 229 is an encoder wheel having a circumference of one foot, which produces 4096 pulses per revolution. In various other embodiments, the encoder wheel produces 2048 pulses per revolution. The encoder wheel rides on the extrudate 21 and, as the extrudate 21 moves, the encoder wheel rotates, thereby generating pulses proportional to its rate of rotation. Accordingly, by counting pulses, the servo controlled cutter 22 can determine the length and the speed of the extrudate 15 thereby to move and properly cut the extrudate into desired lengths. Once the blade of the cutter has cut through the extrudate 1, the blade is raised above the level of the extrudate 21 so that the extrudate can continue along the extrusion line. In various embodiments, the speed at which the extrudate is extruded can range from about 5 to about 40 feet per minute, and more particularly from about 8 to about 20 feet per minute. The variations in the rate at which the extrudate is extruded can vary by about 1 to 2 feet per minute. Advantageously the present teachings allow for cutting of the extrudate without deforming the extrudate when the rate varies by 1 to 2 feet per minute.

Next, the clamp is released, the saw is retracted back down through the table 25, and the table continues briefly to move at the speed of the extrudate. Then, the table moves backward to its home position in a direction opposite to the movement of the extrudate. In various embodiments, the low friction Teflon™-type strips prevent deforming the elastic portion of the extrudate 15 when the table moves in the opposite direction from the extrudate because of the low coefficient of friction between the hardened extrudate 21 and the Teflon™-type strips. Once the table returns to its home position, the extrudate continues to be extruded to the desired length, pushing the cut piece of composite lumber along, and the process repeats.

As set forth above, various embodiments do not use a puller, which is a two tracked device that can be used to force the extrudate through a calibration die, and thereby render the speed and diameter of the extrudate constant. Such pullers are typically used in connection with PVC pipe manufacturing processes. Various embodiments consistent with the present teachings advantageously avoid the added cost and complexity of using a puller by use of the extrudate speed detector 22 and the servo-controlled cutter 18.

Other embodiments of the invention will be apparent to those skilled in the art from consideration of the specification and practice of the teachings disclosed herein. It is intended that the specification and examples be considered as exemplary only, with a true scope and spirit of the invention being indicated by the following claims.

We claim:

1. A method for manufacturing extruded composite lumber comprising the steps of:
providing composite materials to an extruder having an outlet;
extruding the composite materials at a variable rate to form a composite extrudate;
determining a rate of extrusion of the composite extrudate; and
controlling a servo-controlled cutter based on the rate of extrusion of the composite extrudate.

2. The method of claim 1, wherein the servo-controlled cutter comprises a table having an upper surface, wherein the controlling step comprises:
moving the upper surface in synchrony with the rate of extrusion;
clamping the composite extrudate to the upper surface of the table; and
cutting the composite extrudate.

3. The method of claim 2, wherein the cutting and clamping steps occur during the moving step.

4. The method of claim 2, wherein the moving step comprises shifting the upper surface between first and second positions, and further comprising the step of returning the upper surface to the first position after the cutting step.

5. The method of claim 2, further including the step of unclamping the composite extrudate after the cutting step.

6. The method of claim 1, wherein the rate of extrusion is between 5 and 40 ft/min.

7. The method of claim 1, wherein the rate of extrusion is between 8 and 20 ft/min.

8. The method of claim 1, wherein the variable rate is between 1 and 2 ft/min.
